(19) United States
(12) Patent Application Publication
(10) Pub. No.: US 2019/0354369 A1
(43) Pub. Date: Nov. 21, 2019

(54) COMPUTING ARCHITECTURE TO PROVIDE SIMPLIFIED POST-SILICON DEBUGGING CAPABILITIES

(71) Applicant: SANDISK TECHNOLOGIES, LLC, Plano, TX (US)

(72) Inventors: Vijay Chinchole, Bangalore (IN); Vinayak Ghatawade, Bangalore (IN); Naman Rastogi, Bangalore (IN)

(21) Appl. No.: 15/979,627

(22) Filed: May 15, 2018

(51) Int. Cl. G06F 9/30; G06F 9/38; G06F 13/16

(52) U.S. Cl. CPC G06F 9/3005; G06F 13/1668; G06F 9/3802

(57) ABSTRACT

This disclosure provides techniques for debugging a computing system in a post-silicon validation process. In one example, a system can include a memory storing a set of instructions. The system can include a controller configured to fetch and execute the set of instructions. The system can include a logic block. The system can include a control bus coupling the memory, the controller, and the logic block. The control bus can include a first break-in circuit and a second break-in circuit each coupled to the controller. The first break-in circuit and the second break-in circuit can be configured to selectively cascade a break point from the controller through the logic block to halt execution of the set of instructions.

### BACKGROUND

The present disclosure relates to technology for post-silicon verification of a computing system including semiconductor memory.

Semiconductor memory has become more popular for use in various electronic devices. For example, non-volatile semiconductor memory is used in cellular telephones, digital cameras, personal digital assistants, mobile computing devices, non-mobile computing devices and other devices. Computing systems that include non-volatile memory are becoming more complex. Businesses and consumers want such systems to perform reliably. Therefore, the ability to validate and debug these complex systems in an efficient and cost-effective manner is imperative.

### SUMMARY

The systems, methods and devices of this disclosure each have several innovative aspects, no single one of which is solely responsible for the desirable attributes disclosed herein.

One aspect of this disclosure is directed to an apparatus. The apparatus can include a controller and a control bus coupling the controller to memory. The control bus can include a first break-in circuit configured to send a first break-in pulse to the controller to halt execution of instructions by the controller when a break point is reached in the set of instructions.

In some implementations, the control bus can further include a second break-in circuit configured to send a break-in pulse to a logic block to halt execution within the logic block when the break point is reached in the set of instructions. In some implementations, the logic block can include a break-out circuit configured to send a break-out pulse to a second logic block responsive to receiving the break-in pulse from the second break-in circuit.

In some implementations, the memory can further include a register configured to store a value corresponding to a state of the break-in enable signal associated with the logic block. In some implementations, the register can further store a value corresponding to a restart command for the logic block. In some implementations, the logic block can be further configured to resume its execution based on a predetermined value of the restart command stored in the register.

Another aspect of this disclosure is directed to an apparatus. The apparatus can include a controller configured to fetch a set of instructions. The apparatus can include a logic block configured to receive the set of instructions from the controller via a control bus communicatively coupling the controller and the logic block. The control bus can be configured to initiate a break point that pauses execution of instructions by the controller.

In some implementations, the control bus can be further configured to determine the break point and, responsive to the determination of the break point, send a break-in pulse to the controller to cause the controller to pause execution and to send a break-out pulse to the logic block. In some implementations, the control bus can be further configured to send a break-in pulse to the logic block responsive to both the break-out pulse from the controller and a break-in enable signal associated with the logic block to cause the logic block to halt execution.

In some implementations, the control bus can be further configured to determine an opcode associated with an instruction of the set of instructions, and to determine the break point from the opcode. In some implementations, the control bus can be further configured to determine that a value of the opcode corresponds to a break-in value. The control bus can be further configured to retrieve a replacement portion of the instruction from a breakpoint table. The control bus can be further configured to replace the opcode of the instruction with the replacement portion of the instruction. In some implementations, the control bus can be further configured to compare an address of an instruction to a stored break-in address value to determine a match between the address of the instruction and the break-in address. The control bus can also be configured to determine the break point, responsive to the match.

Another aspect of this disclosure is directed to a system. The system can include a memory storing a set of instructions. The system can include a controller configured to fetch and execute the set of instructions. The system can include a logic block. The system can include a control bus coupling the memory, the controller, and the logic block. The control bus can include a first break-in circuit and a second break-in circuit each coupled to the controller. The first break-in circuit and the second break-in circuit can be configured to selectively cascade a break point from the controller through the logic block to halt execution of the set of instructions.

In some implementations, the first break-in circuit can be configured to selectively halt execution of the set of instructions by the controller in response to the break point. The second break-in circuit can be further coupled to the logic block and can be configured to send a break-in pulse to the logic block to selectively halt execution of the logic block in response to the break point. In some implementations, the logic block can be configured to further cascade the break point by sending a break-out pulse to a second logic block responsive to receiving the break-in pulse from the second break-in circuit.

In some implementations, the memory can include a debug register having at least one bit corresponding to a restart command to cause the controller to resume processing of the set of instructions. In some implementations, the system can include a display configured to generate a debug user interface. The system can also include an input device configured to allow a user to interact with the debug user interface to alter the at least one bit of the debug register.

Another aspect of this disclosure is directed to a method. The method can include fetching, by a controller, a set of instructions stored in a memory. The method can include delivering the set of instructions to a logic block via a control bus to cause the logic block to execute the set of instructions sequentially. The method can include determining, by a first break-in circuit of the control bus, a break point in the set of instructions. The method can include, responsive to the determination of the break point, sending, by the first break-in circuit, a break-in pulse to the controller to cause the controller to halt its execution and send a break-out pulse to the logic block.

In some implementations, the method can include sending, by a second break-in circuit coupled to the logic block, a break-in pulse to the logic block responsive to receiving both the break-out pulse from the controller and a break-in enable signal associated with the logic block. In some implementations, the method can include storing, by the memory, a value corresponding to a state of the break-in enable signal associated with the logic block in a register of the memory. In some implementations, the method can include determining, by the first break-in circuit, a value of at least one bit of an opcode associated with an instruction of the set of instructions. The method can also include determining, by the first break-in circuit, the break point, based on the value of the at least one bit.

In some implementations, the method can include determining, by the first break-in circuit, that a value of an opcode of an instruction corresponds to a break-in value. The method can also include determining, by the first break-in circuit, the break point, based on the value of the opcode of the instruction. The method can also include retrieving, by the first break-in circuit, a replacement portion of the instruction from a breakpoint table. The method can also include replacing, by the first break-in circuit, the opcode of the instruction with the replacement portion of the instruction.

In some implementations, the method can also include storing, by the first break-in circuit, a break-in address value. The method can also include comparing, by the first break-in circuit, an address of an instruction to the break-in address value to determine a match between the address of the instruction and the break-in address. The method can also include determining, by the first break-in circuit, the break point, responsive to the match.

Another aspect of this disclosure is directed to an apparatus. The apparatus can include means for storing a set of instructions. The apparatus can include means for executing the set of instructions. The apparatus can include means for controlling execution of the means for executing the set of instructions. The apparatus can include means for halting execution of the means for controlling and the means for executing when a break point is reached in the set of instructions. The means for halting can couple the means for storing, the means for executing, and the means for controlling.

### BRIEF DESCRIPTION OF THE DRAWINGS

FIG. 1 is a block diagram depicting components of a controller-based computing system, according to an example implementation.

FIG. 2 is block diagram of a controller-based computing system incorporating a control bus architecture to facilitate debugging operations, according to an example implementation.

FIG. 3 is a representation of a break point table that can be used in connection with the control bus architecture of FIG. 2, according to an example implementation.

FIGS. 4A-4C are various representations of debug registers that can be used in connection with the control bus architecture of FIG. 2, according to example implementations.

FIG. 5 is a flow diagram of a process for debugging a computing system, according to an example implementation.

### DETAILED DESCRIPTION

Reference will now be made to various embodiments, one or more examples of which are illustrated in the figures. The embodiments are provided by way of explanation of the invention, and are not meant as a limitation of the invention. For example, features illustrated or described as part of one embodiment may be used with another embodiment to yield still a further embodiment. It is intended that the present application encompass these and other modifications and variations as come within the scope and spirit of the invention.

Disclosed herein are technologies directed to validation of computing systems that may include non-volatile memory. The disclosed technologies can be used to improve the design of such computing systems to render the computing systems easier to debug. Generally, debugging a computing system can be done in a pre-silicon context, in which the computing device is designed and simulated in a software or hardware description language, or in a post-silicon context, in which the design of the computing device has been implemented using physical hardware. This disclosure relates primarily to debugging in a post-silicon context. Specifically, the disclosed technology can improve debugging capabilities while reducing costs for validating computing systems in a post-silicon context.

Post-silicon validation of computing devices is becoming more difficult and, in some instances, prohibitively expensive due to the complexity of modern computing systems. Current post-silicon techniques for validating a computing system may provide only limited access to internal signals. As a result, controllability of the systems and observability of the internal signals during the validation process can be insufficient for debugging purposes. When a problem is encountered as a system-level failure with such a system, it can be challenging to localize the problem to a small region within the computing system. Thus, identifying the root cause of the problem may be difficult or impossible.

Pre-silicon validation can remedy some of the issues that may be encountered in the post-silicon context. For example, in the pre-silicon context, the system is typically much more easily controlled and internal signals are easier to observe. However, pre-silicon validation relies on simulations that may not accurately reflect all characteristics of the hardware eventually used to implement the simulations. For example, some physical effects of a complex computing system are difficult or impossible to model via a simulation. Therefore, a design for a computing system that passes a pre-silicon validation process may still experience problems when it is implemented in the post-silicon context. To address these challenges, this disclosure provides an architecture for a control bus that can be used to improve debugging capabilities in the post-silicon context, while reducing the cost and complexity of a computing system.

Generally, a control bus can be any combination of circuitry coupling two or more electronic components in a manner that facilitates transmission of control signals between the components. For example, control signals can include read signals, write signals, clock signals, interrupt request signals, and any other suitable computing signals known to those of skill in the art. Thus, many of the components of a control bus can be passive electronic components, such as wires, communication lines, or conductive traces that electrically couple two components. In addition to these passive components, the control bus architecture described in this disclosure can include active components that can facilitate debugging operations that may be performed during a validation process, such as stopping execution of a set of instructions, restarting execution of the set of instructions, or sequentially stepping through individual instructions. For example, these types of active components can include break-in circuits that may be configured to determine when break points are reached in a set of instructions and to generate signals to cause stopping, restarting, or stepping of the instructions in response.

The break-in circuits described herein can be incorporated directly into the control bus such that it constitutes a portion of the control bus. Stated differently, the break-in circuits can be formed integrally with other operational components of a computing device, such as processors, controllers, and logic blocks. As a result, the break-in circuits represent an “on-chip” solution that allows break-in pulses and other debugging signals to be generated on the same chip as the operational components whose functions are being debugged. Such an architecture can be simpler and less expensive to fabricate than an “off-chip” solution, which typically requires additional interface circuitry built into the chip, as well as external equipment located off-chip that couples to the additional interface.

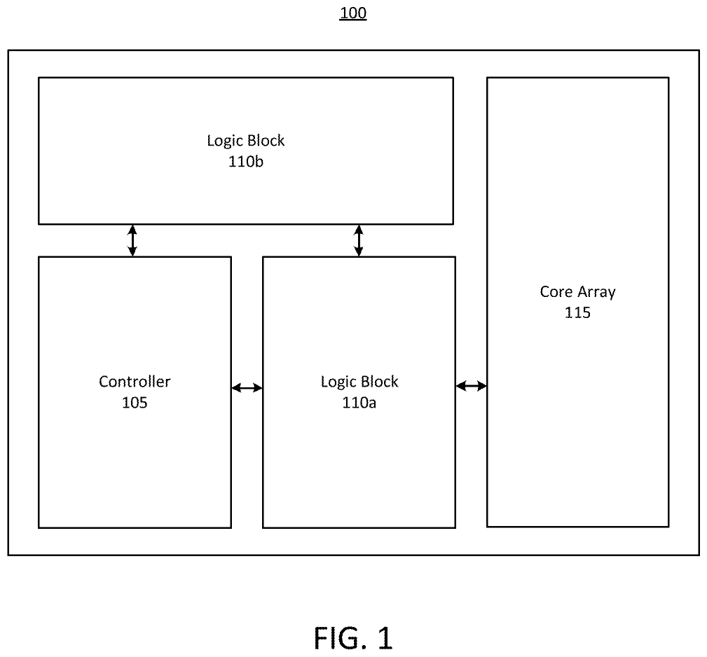

FIG. 1 is a block diagram depicting components of a controller-based computing system 100, according to an example implementation. The system 100 includes a controller 105, logic blocks 110a and 110b (generally referred to as logic blocks 110), and a core array 115. The controller 105, the logic block 110a, and the logic block 110b are communicatively coupled to one another. The logic block 110a is also communicatively coupled to the core array 115.

In some implementations, the system 100 can be a user-programmable non-volatile memory system. For example, the core array 115 can serve as a memory device that is programmable via the controller 105 and the logic blocks 110. The core array 115 can be implemented using any of a wide variety of types of memory. For example, in some implementations, the core array 115 can be a flash memory system. A flash memory system using a NAND structure will include several NAND strings. Each NAND string is connected to the common source line by its source select gate controlled by select line SGS and connected to its associated bit line by its drain select gate controlled by select line SGD. Each bit line and the respective NAND string(s) that are connected to that bit line via a bit line contact comprise the columns of the array of memory cells. Bit lines are shared with multiple NAND strings. In certain embodiments, the bit line runs on top of the NAND strings in a direction perpendicular to the word lines and is connected to a sense amplifier. In some implementations, the core array 115 can be a charge trap NAND memory device or a floating gate NAND memory device.

Other types of non-volatile storage devices, in addition to NAND flash memory, can also be used to implement the core array 115 making use of the new technology described herein. For example, a TANOS structure (consisting of layers of TaN—Al2O3—SiN—SiO2 on a silicon substrate), which is a memory cell configured to trap charge in a nitride layer (instead of a floating gate), can also be used with the technology described herein. Another type of memory cell useful in flash EEPROM systems utilizes a non-conductive dielectric material in place of a conductive floating gate to store charge in a non-volatile manner. Such a cell is described in an article by Chan et al., “A True Single-Transistor Oxide-Nitride-Oxide EEPROM Device,” IEEE Electron Device Letters, Vol. EDL-8, No. 3, March 1987, pp. 93-95. A triple layer dielectric formed of silicon oxide, silicon nitride and silicon oxide (“ONO”) is sandwiched between a conductive control gate and a surface of a semi-conductive substrate above the memory cell channel. The cell is programmed by injecting electrons from the cell channel into the nitride, where they are trapped and stored in a limited region. This stored charge then changes the threshold voltage of a portion of the channel of the cell in a manner that is detectable. The cell is erased by injecting hot holes into the nitride. See also Nozaki et al., “A 1-Mb EEPROM with MONOS Memory Cell for Semiconductor Disk Application,” IEEE Journal of Solid-State Circuits, Vol. 26, No. 4, April 1991, pp. 497-501, which describes a similar cell in a split-gate configuration where a doped polysilicon gate extends over a portion of the memory cell channel to form a separate select transistor.

Another example is described by Eitan et al., “NROM: A Novel Localized Trapping, 2-Bit Nonvolatile Memory Cell,” IEEE Electron Device Letters, vol. 21, no. 11, November 2000, pp. 543-545. An ONO dielectric layer extends across the channel between source and drain diffusions. The charge for one data bit is localized in the dielectric layer adjacent to the drain, and the charge for the other data bit is localized in the dielectric layer adjacent to the source. U.S. Pat. No. 7,005,350 discloses a non-volatile memory cell having a trapping dielectric sandwiched between two silicon dioxide layers. Multi-state data storage is implemented by separately reading the binary states of the spatially separated charge storage regions within the dielectric.

Other types of non-volatile memory technologies may also be used in conjunction with the technology disclosed herein. For example, any suitable type of solid-state storage media may be used, such as, among others, NOR flash memory, nano RAM (“NRAM”), magneto-resistive RAM (“MRAM”), phase change RAM (“PRAM”), Racetrack memory, Memristor memory, nanocrystal wire-based memory, silicon-oxide based sub-10 nanometer process memory, graphene memory, Resistive random-access memory (“RRAM”), programmable metallization cell (“PMC”), and conductive-bridging RAM (“CBRAM”).

One example of a ReRAM memory includes reversible resistance-switching elements arranged in cross-point arrays accessed by X lines and Y lines (e.g., word lines and bit lines). In another embodiment, the memory cells may include conductive bridge memory elements. A conductive bridge memory element may also be referred to as a programmable metallization cell. A conductive bridge memory element may be used as a state change element based on the physical relocation of ions within a solid electrolyte. In some cases, a conductive bridge memory element may include two solid metal electrodes, one relatively inert (e.g., tungsten) and the other electrochemically active (e.g., silver or copper), with a thin film of the solid electrolyte between the two electrodes. As temperature increases, the mobility of the ions also increases causing the programming threshold for the conductive bridge memory cell to decrease. Thus, the conductive bridge memory element may have a wide range of programming thresholds over temperature.

Magnetoresistive memory (MRAM) stores data by magnetic storage elements. The elements are formed from two ferromagnetic plates, each of which can hold a magnetization, separated by a thin insulating layer. One of the two plates is a permanent magnet set to a particular polarity; the other plate's magnetization can be changed to match that of an external field to store memory. This configuration is known as a spin valve and is the simplest structure for an MRAM bit. A memory device is built from a grid of such memory cells. In one embodiment for programming, each memory cell lies between a pair of write lines arranged at right angles to each other, parallel to the cell, one above and one below the cell. When current is passed through them, an induced magnetic field is created.

Phase change memory (PCRAM) exploits the unique behavior of chalcogenide glass. One embodiment uses a GeTe—Sb2Te3 super lattice to achieve non-thermal phase changes by simply changing the co-ordination state of the Germanium atoms with a laser pulse (or light pulse from another source). Therefore, the doses of programming are laser pulses. The memory cells can be inhibited by blocking the memory cells from receiving the light. Note that the use of “pulse” in this document does not require a square pulse, but includes a (continuous or non-continuous) vibration or burst of sound, current, voltage light, or other wave.

In some implementations, a controller such as the controller 105 can be any component capable of commanding, controlling, or otherwise influencing the operation of the logic blocks 110. Thus, in these implementations, the controller 105 can be considered a means for controlling the logic block 110a or the logic block 110b. Accordingly, the controller 105 can be implemented in a variety of ways, including as an integrated circuit, a microcontroller, general purpose processor, or any other type of circuitry capable of influencing the operation of the logic blocks 110. The logic blocks 110 can each be any combination of computer hardware and software configured to perform logical operations based on commands or control signals received from the controller 105.

In some implementations, the logic block 110a can be an analog voltage logic block. For example, the logic block 110a can be configured to output analog voltages to the core array 115 to cause the core array 115 to store or erase data. The logic block 110a can also be configured to read data stored by the core array 115 and to pass the read data back to the controller 105 or to the logic block 110b. In some implementations, the logic block 110b can serve as a datapath logic block. For example, signals corresponding to data to be written to the core array 115, or signals corresponding to addresses within the core array 115 to be accessed in a read operation, can be transmitted from the controller 105 to the logic block 110a via the logic block 110b. The data can be, for example, blocks of 16 kB data transmitted between the controller 105 and the logic block 110a via the logic block 110b.

In some implementations, it can be useful to perform validation, including debugging, of a controller-based computing system such as the system 100. Such validation may require observation and control over the signals within the controller 105, the logic block 110a, and the logic block 110b, as well as the signals that pass between these components. However, due to the complexity of the system 100, such observation and control can be difficult to achieve in the post-silicon context. Some conventional solutions to this problem make use of additional circuitry and interfaces dedicated to validation and debugging functionality. Such additional circuitry and interfaces can be coupled to other external equipment (e.g., equipment that is not included within the system 100) for validation purposes, such as through a joint test action group (JTAG) interface. However, providing this additional hardware in the post-silicon environment increases the cost and complexity of the overall system and requires additional off-chip equipment to enable debugging functionality, with no corresponding improvement in the normal operating performance of the device, as the additional circuitry exists only for validation and debugging purposes.

Described further below are technologies that can instead provide validation and debugging functionality by reusing functional components of the system 100, such as a control bus that can couple the controller 105, the logic block 110a, and the logic block 110b. Because these functional components can be reused for debugging purposes, the resulting device can be simpler and less expensive to manufacture than a device having similar operational performance characteristics with the addition of complex circuitry dedicated only to validation and debug functionality.

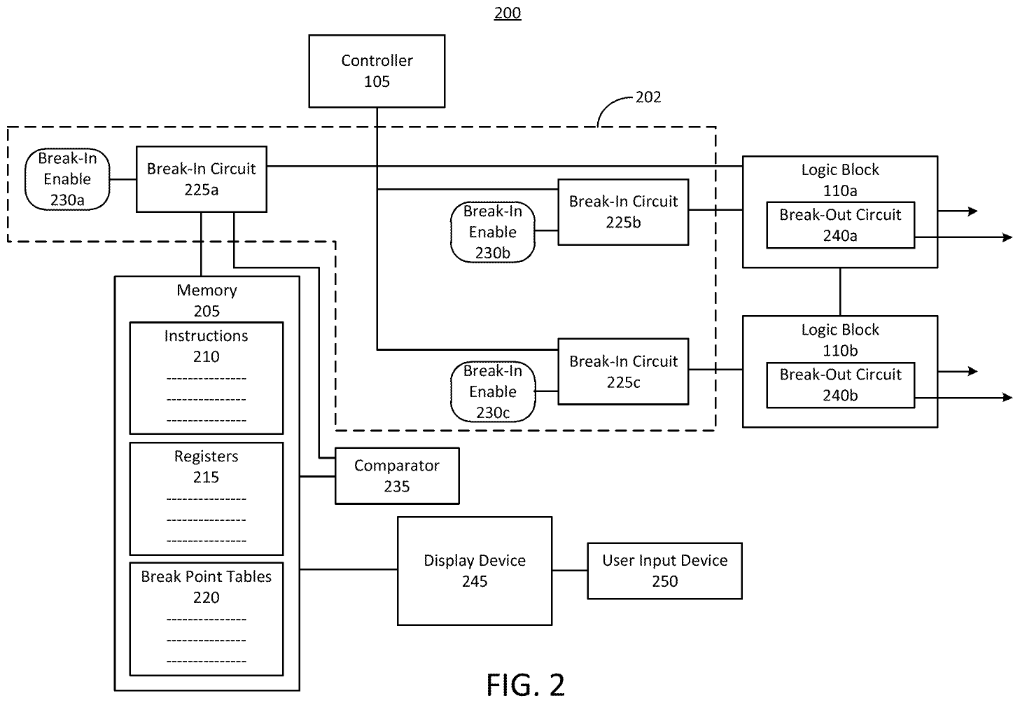

FIG. 2 is block diagram of a controller-based computing system architecture 200 incorporating a control bus architecture 202 to facilitate debugging operations, such as the system 100 shown in FIG. 1, according to an example implementation. The system 200 includes components similar to those of the system 100 shown in FIG. 1, such as the controller 105, the logic block 110a, and the logic block 110b. For illustrative purposes, the core array 115 is not shown in FIG. 2. The controller 105, the logic block 110a, and the logic block 110b are coupled to one another via a control bus 202, which may include any circuitry necessary for facilitating transmission of control signals, such as read signals, write signals, clock signals, interrupt request signals, and the like, between these components. For example, the lines connecting the controller 105, the logic block 110a, and the logic block 110b all can represent portions of the control bus 202, which in practice may be implemented as multiple communication channels fabricated as wires, conductive traces, or the like. Break-in circuits 225a-225c (generally referred to as break-in circuits 225), which can be coupled to the controller 105, the logic block 110a, and the logic block 110b via these communication channels, also can be considered part of the control bus 202.

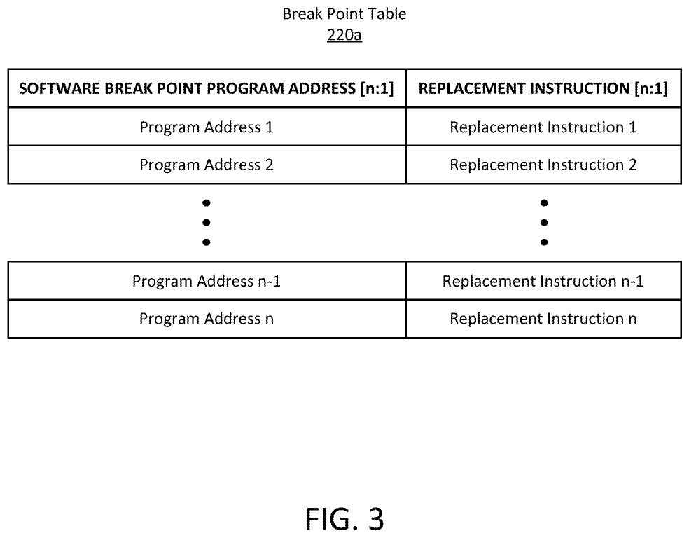

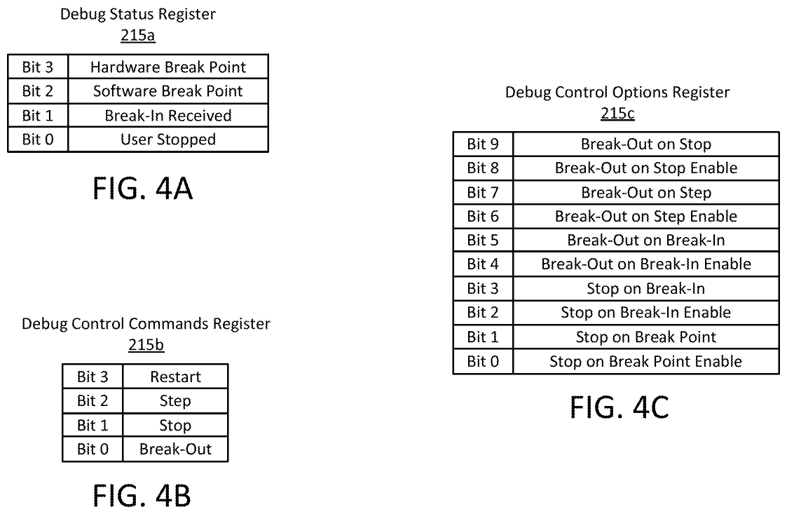

In some implementations, the system 200 also includes a memory 205 that can store instructions 210, registers 215, and break point tables 220. In these implementations, the memory 205 may be considered a means for storing the set of instructions 210. Generally, the memory 205 can be any structure capable of storing information, such as any type or form of computer memory including RAM or ROM. The memory 205 can include sequential slots each configured to store a predetermined amount of computer information, and each of which has a respective program address. In some implementations, the registers 215 can each be any subset of the program addresses of the memory 205 dedicated to storing values for predetermined parameters at each program address in the register 215, examples of which are provided below in connection with FIGS. 4A-4C. Similarly, the break point tables 220 can each be any subset of the program addresses of the memory 205 dedicated to storing values for predetermined parameters at each program address in the break point table 220, examples of which are provided below in connection with FIG. 3.

The controller 105 can be configured to fetch the instructions 210 from the memory 205. The controller 105 can process the instructions 210 to generate commands, including control signals to be transmitted via the control bus to the logic block 110a and the logic block 110b. In some implementations, the controller 105 can be configured to fetch the instructions 210 and to send the instructions 210 to the logic blocks 110 for execution by the logic blocks 110. In these implementations, the logic blocks 110 may be considered means for executing the instructions 210. To facilitate debugging, the control bus 202 also includes additional circuitry, such as the break-in circuits 225, each of which receives a respective break-in enable signal 230a-230c (generally referred to as break-in enable signals 230). The break-in circuit 225a can be configured to send a break-in pulse to the controller 105, the break-in circuit 225b can be configured to send a break-in pulse to the logic block 110a, and/or the break-in circuit 225c can be configured to send a break-in pulse to the logic block 110b.

Generally, a break-in pulse can be any type of signal received by a logic block 110 or by the controller 105 to cause that component to halt, pause, or stop its execution when the break-in pulse is received. Thus, break-in pulses can be used for debugging purposes because they can provide precise control over the execution of the functional components of the system. A user (e.g., an engineer performing a validation process on the system 200) can select break points at which the execution of one or more of the controller 105, the logic block 110a, and the logic block 110b should be halted. Generally, a break point can be specified based on a corresponding one of the instructions 210 stored in the memory 205. For example, a break point can be specified based on the program address of a particular instruction 210. Such a program address can also be referred to as a break-in address value. Thus, the user selects break points within the set of instructions 210, and the components of the control bus 202 provide appropriate break-in pulses to any of the controller 105, the logic block 110a, and the logic block 110b when these break points are reached.

Determination of a break point within the instructions 210 and corresponding generation of a break-in pulse can be referred to as initiation of the break point. A break-in circuit, such as any of the break-in circuits 225, can generally be any combination of circuitry capable of providing a break-in pulse to the controller 105 or the logic blocks 110 when a break point is reached (i.e., capable of initiating a break point). Thus, the break-in circuit 225a may be considered a means for halting or pausing execution of the controller 105, the break-in circuit 225b may be considered a means for halting execution of the logic block 110a, and the break-in circuit 225c may be considered a means for halting the logic block 110b. In some implementations, a break-in circuit 225 may be implemented at least partially using software. For example, a break-in circuit 225 can be or can include a processor, an application-specific integrated circuit (ASIC), a field programmable gate array (FPGA), a microcontroller, or any other type of component or combination of components configured to execute computer instructions to cause the component to generate a break-in pulse when a break point is reached. Thus, each break-in circuit 225 may also be referred to as a break-in component.

In some implementations, operation of the break-in circuits 225 can be further controlled by their respective break-in enable signals 230. For example, each break-in circuit 225 receives at least two inputs, one of which corresponds to its respective break-in enable signal 230. In some implementations, the break-in circuits 225 can implement a logical AND function causing the break-in circuit 225 to produce a break-in pulse only if the respective break-in enable signal 230 is present when at least one other input to the break-in circuit 225 indicates a break point is reached. For example, each of the break-in circuits 225 can be or can include an AND gate configured to generate a break-in pulse when its respective break-in enable signal 230 is present and at least one other input to the break-in circuit 225 indicates a break point is reached.

The timing of a break point can be configurable by a user. In some implementations, a break point can be based on a particular one of the instructions 210 being fetched from the memory 205. For example, a break point can be triggered when a particular program address is reached in the set of instructions 210. In other examples, a break point can be triggered based on an opcode of an instruction, regardless of its program address. In still other examples, a user can manually trigger a break point, for example by using the display device 245 and user input device 250. These and other examples are described further below.

The arrangement of the controller 105, the logic block 110a, the logic block 110b, and their respective break-in circuits 225 can facilitate a high degree of user control over the controller 105 and the logic blocks 110. For example, a break-in pulse delivered from the break-in circuit 225a to the controller 105 can cause the controller 105 to halt its execution without interfering with the execution of the logic block 110a or the logic block 110b. In some other implementations, the break point can be propagated to one or both of the logic blocks 110 in a cascaded manner. For example, the controller 105 can be configured to generate a break-out pulse in response to receiving the break-in pulse from the break-in circuit 225a. Generally, a break-out pulse can be any signal generated as an output by the controller 105 or by one of the logic blocks 110 in response to that component receiving a break-in signal. The break-out pulse generated by the controller 105 can be delivered to the break-in circuits 225b and 225c, which can be configured to send respective break-in pulses to the logic blocks 110a and 110b in response, thereby halting execution of the logic blocks 110a and 110b. Thus, the output of the controller 105 can become the input to the logic blocks 110. In this way, the break point that initially causes the controller to halt can be selectively cascaded to the logic block 110a or to the logic block 110b, or to both the logic block 110a and the logic block 110b.

In addition, the logic block 110a can be configured to cascade a break point received from the controller 105 to the logic block 110b. To achieve this, the logic block 110a includes a break-out circuit 240a. The break-out circuit 240a can be configured to generate a break-out pulse responsive to the logic block 110a receiving a break-in pulse. In some implementations, to provide the cascaded break point functionality referenced above, the output of the break-out circuit 240a can be coupled to the break-in circuit 225c. For example, the output of the break-out circuit 240a can be used as the break-in enable signal 230c. In some implementations, the output of the break-out circuits 240 can be coupled to other components instead. A break-out circuit, such as any of the break-out circuits 240, can generally be any combination of circuitry capable of providing a break-out in response to its respective controller 105 or logic block 110 receiving a break-in pulse. In some implementations, a break-out circuit 240 may be implemented at least partially using software. For example, a break-out circuit 240 can be or can include a processor, an ASIC, an array FPGA, a microcontroller, or any other type of component or combination of components configured to execute computer instructions to cause the component to generate a break-out pulse when the break-in pulse has been received. Thus, each break-out circuit 240 may also be referred to as a break-out component.

In some implementations, the controller 105 can fetch the instructions 210 sequentially from the memory 205. The break-in circuit 225a coupled to the controller 105 can be configured to halt execution of the controller 105 when a break point is reached in the instructions 210. In some implementations, this functionality can be implemented primarily via software. For example, the break-in circuit 225a can include program logic or executable code to evaluate the instructions 210 as they are fetched, and can detect a break point in the instructions based on one or more rules that may be configured by a user. In some implementations, as described further below, these rules may be represented by values stored in the registers 215 or the break point tables 220.

In some implementations, a software break point can be represented by a reserved bit in the instructions 210. For example, the last bit of each instruction can be reserved as a flag to indicate a break point in the set of instructions 210. In some implementations, the reserved bit can be set to 0 for all instructions 210 not intended to trigger a break point, and can be set to 1 for those instructions 210 that are intended to trigger a break point. The break-in circuit 225a can be configured to parse the instructions 210 as they are fetched from the memory 205. When an instruction 210 having a reserved bit is set to 1 is fetched, the break-in circuit 225a can be configured to transmit a break-in pulse to the controller 105 to cause the controller 105 to halt its execution. Because the reserved bit is not available for use in the instruction set, the complexity of the instruction set available in such implementations may be limited.

In some implementations, the system 200 can make use of a reserved opcode in the instruction set, rather than a reserved bit in each instruction 210, to determine a break point. Generally, an opcode can be any portion of an instruction 210 that specifies the operation to be performed for the instruction 210. An instruction 210 can also include other information, such as the data to be processed by the operation specified by the opcode. For example, the leading eight bits (or any other number of bits) of each instruction 210 may be the opcode for the instruction 210. To set a breakpoint at a particular instruction 210, the leading eight bits of the instruction 210 can be replaced with a bit string reserved for break points. The bit string may not serve as a traditional opcode, in that it may not specify any particular operation to be performed. Rather, the purpose of the reserved bit string is to flag the instruction 210 as corresponding to a break point. The original eight bits of the instruction (i.e., the traditional opcode intended for the instruction) can be stored elsewhere in the memory 205, for example in a break point table 220. An example of such a break point table is shown in FIG. 3 as break point table 220a. As illustrated, the break point table 220a can include n rows, where n corresponds to the number of software breakpoints in the set of instructions 210. For each entry in the break point table 220a, a program address and corresponding replacement instruction are stored.

As instructions 210 are fetched from the memory 205, the break-in circuit 225a can determine when a break point is received by comparing the first eight bits of each instruction (i.e., the opcode) to the opcode reserved for break points. When a match is determined, the break-in circuit 225a can generate a break-in pulse to halt execution of the controller 105. In some implementations, an instruction that includes the reserved break point opcode may not be executable, but may instead be used as a placeholder to indicate the break point in the set of instructions. To render the instruction executable, the corresponding entry in the break point table 220a can be used to find the replacement instruction for that program address, and the instructions 210 can be modified to replace the instruction at that program address with the replacement instruction from the corresponding entry in the break point table 220a. As a result, when execution of the controller 105 is restarted and the instructions 210 are again being fetched, the correct instruction 210 (i.e., the replacement instruction) will have already been inserted at the program address that triggered the breakpoint, allowing the correct instruction 210 to be executed. The instructions 210 can then continue to be sequentially fetched and executed until the next break point is reached. It should be noted that, in such implementations, the memory 205 may include a rewriteable form of memory, such as random access memory (RAM) rather than a read-only memory, in order to allow the instructions 210 corresponding to break points to be replaced with replacement instructions from the break point table 220a as needed. In some implementations, a user may specific the program addresses and replacement instructions to be included in the break point table 220a.

In some implementations, hardware elements such as the comparator 235, rather than software, can be used to determine a break point based on a program address of an instruction 210. For example, a user may specify that one or more of the instructions 210 at particular addresses should trigger break points, and the comparator 235 can be programmed with these break point addresses. As instructions 210 are fetched from the memory 205, the comparator 235 can compare the address of each fetched instruction 210 to its stored. When a match is determined (i.e., when a break point is reached), the comparator 235 can transmit an indication of the match to the break-in circuit 225a, to cause the break-in circuit 225a to transmit a break-in pulse to the controller 105.

In some implementations, the registers 215 can store various information related to a current state of the system as well as debug commands received from a user. In addition, the display device 245 can be configured to display an interface to a user allowing the user to examine the values stored by the registers 215. The display device 245 can be any type of device capable of outputting information for view by a user. For example, the display device 245 can be an electronic display of a computing device such as a desktop computer, a laptop computer, a tablet computing device, or a mobile computing device, and can be configured to display information to the user via a user interface. The user interface can be, for example, a graphical user interface. In some implementations, the user can interact with such an interface via the user input device 250 to modify values stored by the registers 215. It should be understood that, while the controller 105, the logic blocks 110, the memory 205, and the break-in circuits 225, may be included on a single chip, the display device 245 and the user input device 250 may in some implementations include one or more devices external to the chip.

For example, the user input device 250 can be a pointing device such as a mouse, a stylus, or a touch screen interface device. In some implementations, the user input device 250 can also include a keyboard device. It should be understood that, in some implementations, the display device 245 and the user input device 250 can be integrated into a single device. For example, a laptop computer can include an electronic display corresponding to the display device 245 as well as a keyboard and trackpad corresponding to the user input device 250. In some implementations, such a device can be configured to receive user inputs via the interface shown on the display device 245 and to communicate those inputs to the registers 215 to modify values stored in the registers 215. Examples of such registers are shown in FIGS. 4A-4C. For example, FIG. 4A shows an example representation of a debug status register 215a. The debug status register 215a can include four bits. Bit 3 can correspond to a hardware break point. For example, bit 3 can be set to a 1 if a hardware break point has been encountered, and can be set to 0 otherwise. Bit 2 can correspond to a software break point. For example, bit 2 can be set to a 1 if a software break point has been encountered, and can be set to 0 otherwise. Bit 1 can be set to a 1 if a break-in pulse has been received (e.g., whether the break-in pulse was triggered by a hardware break point, a software break point, or in some other manner), and Bit 0 can be set to a 1 if the user has stopped execution of the controller 105, for example by interacting with an interface provided on the display device 245.

FIG. 4B shows an example representation of a debug control commands register 215b. The debug control commands register 215b can include four bits, each corresponding to a command that may input by a user via an interface provided on the display device 245. Bit 3 can correspond to a restart command. For example, a restart command can cause the controller 105 to restart its execution after it has been halted. Bit 3 can correspond to a step command. In some implementations, a step command can cause a single one of the instructions 210 to be fetched and executed before execution of the controller 105 is halted again. For example, the user may repeatedly issue step commands to slowly step through sequential instructions 210, examining the effects of each instruction 210 after it is executed and before issuing the next step command. Bit 1 can correspond to a stop command. A stop command can cause the controller 105 to halt its execution. For example, if the user issues a stop command, the break-in circuit 225a can transmit a break-in pulse to the controller 105 to cause the controller 105 to halt its execution. Bit 0 can correspond to a break-out command. A break-out command can cause the controller 105 to output a break-out signal that can be transmitted to the logic block 110a and the logic block 110b, as described above.

FIG. 4C shows an example representation of a debug control options register 215c. The debug control options register 215c can include 10 bits corresponding to desired behaviors for the controller 105 in response to various conditions, which may include any of the commands represented by the debug control commands register 215b. The bits of the debug control options register 215c can be grouped into five pairs, each including an enable bit for a desired behavior and a corresponding bit that can be set when that behavior is performed. For example, bits 8 and 9 can correspond to a break-out on stop enable bit and a break-out on stop bit, respectively. A user can set bit 8 (i.e., the enable bit for the “break-out on stop” behavior) to cause the controller 105 to generate the break-out signal when its execution is stopped. In some implementations, the user can set this enable bit via an interface provided through the display device 245. Then, when the controller 105 stops its execution (e.g., in response to receiving a stop command or a break-in pulse from the break-in circuit 225a), the controller 105 can respond by also outputting the break-out signal to the logic block 110a and the logic block 110b, and the corresponding bit in the debug control options register 215c (i.e., bit 9) can be set to provide an indication to the user that the controller 105 has generated the break-out signal in response to its execution being stopped.

Another pair of bits included in the debug control options register 215c can correspond to a “break-out on step” behavior. As shown, bit 6 is the enable bit for this behavior. When the user sets bit 6 to a 1, the controller 105 can be configured to generate the break-out pulse in response to receiving a step command. When the controller 105 performs this behavior, bit 7 can be set to a 1 to provide an indication to the user that the controller 105 has generated the break-out signal in response to receiving a step command.

A third pair of bits included in the debug control options register 215c can correspond to a “break-out on break-in” behavior. As shown, bit 4 is the enable bit for this behavior. When bit 4 is set to a 1 to enable this behavior, the controller 105 can be configured to generate the break-out pulse in response to receiving a break-in pulse from the break-in circuit 225a. When the controller 105 performs this behavior, bit 5 can be set to a 1 to provide an indication to the user that the controller 105 has generated the break-out signal in response to receiving a break-in pulse.

A fourth pair of bits included in the debug control options register 215c can correspond to a “stop on break-in” behavior. As shown, bit 2 is the enable bit for this behavior. When bit 2 is set to a 1 to enable this behavior, the controller 105 can be configured to stop its execution in response to receiving a break-in pulse from the break-in circuit 225a. When the controller 105 performs this behavior, bit 3 can be set to a 1 to provide an indication to the user that the controller 105 has stopped its execution in response to receiving a break-in pulse.

A fifth pair of bits included in the debug control options register 215c can correspond to a “stop on break point” behavior. As shown, bit 0 is the enable bit for this behavior. When bit 0 is set to a 1 to enable this behavior, the controller 105 can be configured to stop its execution in response to a break point being reached in the set of instructions. The break point may be either a software break point or a hardware break point, as described above. When the controller 105 performs this behavior, bit 1 can be set to a 1 to provide an indication to the user that the controller 105 has stopped its execution in response to the break point.

It should be understood that the registers 215 shown in FIGS. 4A-4C are illustrative only. In some implementations, the memory 205 may include more or fewer registers 215, each of which may include more or fewer fields than those that are depicted. For example, in some implementations, the memory 205 may store a respective debug status register 215a, a respective debug control commands register 215b, and a respective debug control options register 215c for each of the controller 105, the logic block 110a, and the logic block 110b. This can allow the user to control the functionality of the controller 105, the logic block 110a, and the logic block 110b independently of one another, and also to determine the status of these components during a debug process.

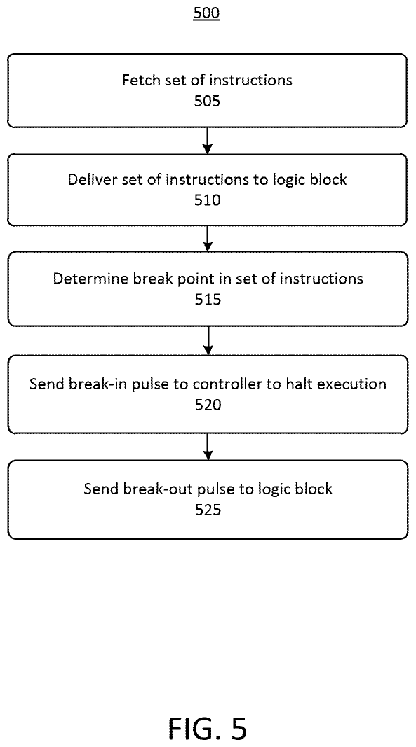

FIG. 5 is a flow diagram of a process 500 for debugging a computing system, according to an example implementation. In some implementations, the process 500 can be performed using the system 200 that includes the control bus 202 shown in FIG. 2. In an operation 505, the process 500 can include fetching a set of instructions. The set of instructions can be stored in a memory, such as the memory 205 shown in FIG. 2. In some implementations, the controller 105 can fetch the set of instructions. In an operation 510, the process 500 can include delivering the set of instructions to a logic block via a control bus to cause the logic block to execute the set of instructions sequentially. For example, the controller 105 can sequentially transmit the instructions to either or both of the logic block 110a and the logic block 110b. In some implementations, the controller can process the instructions to generate a set of commands based on the instructions. In some implementations, the controller can be configured to transmit the generated commands, rather than the set of instructions, to either or both of the logic block 110a and the logic block 110b.

In an operation 515, the process 500 can include determining a break point in the set of instructions. In some implementations, the control bus can also include a first break-in circuit such as the break-in circuit 225a. The break-in circuit 225a can be configured to determine the break point. For example, in some implementations, the break-in circuit 225a can determine a software break point in the instructions by examining a reserved bit of each instruction (e.g., the least significant bit of each instruction) to determine whether the bit indicates that the instruction represents a break point. In some implementations, the reserved bit may normally be set to a value of 0, and may be set to a value of 1 only for those instructions corresponding to break points.

In some other implementations, the break-in circuit 225a may instead determine the break point by examining an opcode of each instruction and comparing the opcode to an opcode reserved for break points. For example, the first 8 bits of each instruction may correspond to opcodes defined by the instruction set used by the computing system. In some implementations, an instruction including the reserved break point opcode may serve only as a placeholder to indicate the break point, but may not itself be executable. Thus, when the break-in circuit 225a detects an instruction corresponding to a break point in this manner, that instruction also may be updated to replace the instruction (or at least a portion of the instruction, such as the portion corresponding to the reserved break point opcode) with a replacement instruction that is executable. In some implementations, the replacement instruction (or replacement portion of the instruction) can be stored in a break point table, such as the break point table 220a shown in FIG. 3.

In still other implementations, an additional hardware component, such as the comparator 235, can be configured to facilitate identification of the breakpoint. For example, the comparator 235 can be programmed with a program address corresponding to a desired break point, and the comparator 235 can examine the program address for each instruction as the instructions are sequentially fetched during operation 505. When an instruction whose program address matches the desired break point program address, the comparator 235 transmits an indication of the match to the break-in circuit 225a, which can determine that the break point has been reached in response.

In an operation 520, the process 500 can include sending a break-in pulse to the controller to halt execution of the controller. In some implementations, the break-in pulse can be generated and sent to the controller 105 by the break-in circuit 225a. The controller 105 can be configured to respond to the break-in pulse by stopping its execution. In some implementations, the controller 105 can be further configured to execute operation 525 of the process 500 by sending a break-out pulse to a logic block, such as the logic block 110a or the logic block 110b shown in FIG. 2. For example, the break-out pulse can cause the logic block that receives the break-out pulse to stop its own execution. In this way, the break point can be cascaded through the controller 105 to either or both of the logic block 110a and the logic block 110b.

The foregoing description is directed to certain implementations for the purposes of describing the innovative aspects of this disclosure. However, a person having ordinary skill in the art will readily recognize that the teachings herein can be applied in a multitude of different ways. The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an ASIC, an FPGA or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, directional terms are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a controller; and
a control bus coupling the controller to memory, wherein the control bus comprises
a first break-in component configured to send a first break-in pulse to the controller to halt execution of instructions by the controller when a break point is reached in the set of instructions.

2. The apparatus of claim 1, wherein the control bus further comprises a second break-in component configured to send a break-in pulse to a logic block to halt execution within the logic block when the break point is reached in the set of instructions.

3. The apparatus of claim 2, wherein the logic block comprises a break-out component configured to send a break-out pulse to a second logic block responsive to receiving the break-in pulse from the second break-in component.

4. The apparatus of claim 1, wherein the memory further comprises a register configured to store a value corresponding to a state of the break-in enable signal associated with the logic block.

5. The apparatus of claim 4, wherein the register further stores a value corresponding to a restart command for the logic block.

6. The apparatus of claim 5, wherein the logic block is further configured to resume its execution based on a predetermined value of the restart command stored in the register.

7. An apparatus comprising:
a controller configured to fetch a set of instructions;
a logic block configured to receive the set of instructions from the controller via a control bus communicatively coupling the controller and the logic block;
wherein the control bus is configured to initiate a break point that pauses execution of instructions by the controller.

8. The apparatus of claim 7, wherein the control bus is further configured to:
determine the break point; and
responsive to the determination of the break point, send a break-in pulse to the controller to cause the controller to pause execution and to send a break-out pulse to the logic block.

9. The apparatus of claim 8, wherein the control bus is further configured to send a break-in pulse to the logic block responsive to both the break-out pulse from the controller and a break-in enable signal associated with the logic block to cause the logic block to halt execution.

10. The apparatus of claim 8, wherein the control bus is further configured to:
determine an opcode associated with an instruction of the set of instructions; and
determine the break point from the opcode.

11. The apparatus of claim 10, wherein the control bus is further configured to:
determine that a value of the opcode corresponds to a break-in value;
retrieve a replacement portion of the instruction from a breakpoint table; and
replace the opcode of the instruction with the replacement portion of the instruction.

12. The apparatus of claim 8, wherein the control bus is further configured to:
compare an address of an instruction to a stored break-in address value to determine a match between the address of the instruction and the break-in address; and
responsive to the match, determine the break point.

13. A system comprising:
a memory storing a set of instructions;
a controller configured to fetch and execute the set of instructions;
a logic block; and
a control bus coupling the memory, the controller, and the logic block, wherein the control bus comprises:
a first break-in circuit and a second break-in circuit each coupled to the controller, wherein the first break-in circuit and the second break-in circuit are configured to selectively cascade a break point from the controller through the logic block to halt execution of the set of instructions.

14. The system of claim 13, wherein the first break-in circuit is configured to selectively halt execution of the set of instructions by the controller in response to the break point, and wherein the second break-in circuit is further coupled to the logic block and is configured to send a break-in pulse to the logic block to selectively halt execution of the logic block in response to the break point.

15. The system of claim 14, wherein the logic block is configured to further cascade the break point by sending a break-out pulse to a second logic block responsive to receiving the break-in pulse from the second break-in circuit.

16. The system of claim 13, wherein the memory includes a debug register having at least one bit corresponding to a restart command to cause the controller to resume processing of the set of instructions.

17. The system of claim 13, further comprising:
a display configured to generate a debug user interface; and
an input device configured to allow a user to interact with the debug user interface to alter the at least one bit of the debug register.

18. A method comprising:
fetching, by a controller, a set of instructions stored in a memory;
delivering the set of instructions to a logic block via a control bus to cause the logic block to execute the set of instructions sequentially;
determining, by a first break-in circuit of the control bus, a break point in the set of instructions;
responsive to the determination of the break point, sending, by the first break-in circuit, a break-in pulse to the controller to cause the controller to halt its execution and send a break-out pulse to the logic block.

19. The method of claim 18, further comprising:
sending, by a second break-in circuit coupled to the logic block, a break-in pulse to the logic block responsive to receiving both the break-out pulse from the controller and a break-in enable signal associated with the logic block.

20. The method of claim 19, further comprising:
storing, by the memory, a value corresponding to a state of the break-in enable signal associated with the logic block in a register of the memory.

21. The method of claim 18, further comprising:
determining, by the first break-in circuit, a value of at least one bit of an opcode associated with an instruction of the set of instructions; and
determining, by the first break-in circuit, the break point, based on the value of the at least one bit.

22. The method of claim 18, further comprising:
determining, by the first break-in circuit, that a value of an opcode of an instruction corresponds to a break-in value;
determining, by the first break-in circuit, the break point, based on the value of the opcode of the instruction;
retrieving, by the first break-in circuit, a replacement portion of the instruction from a breakpoint table; and
replacing, by the first break-in circuit, the opcode of the instruction with the replacement portion of the instruction.

23. The method of claim 18, further comprising:
storing, by the first break-in circuit, a break-in address value;
comparing, by the first break-in circuit, an address of an instruction to the break-in address value to determine a match between the address of the instruction and the break-in address; and
determining, by the first break-in circuit, the break point, responsive to the match.

24. An apparatus comprising:
means for storing a set of instructions;
means for executing the set of instructions;
means for controlling execution of the means for executing the set of instructions; and
means for halting execution of the means for controlling and the means for executing when a break point is reached in the set of instructions, wherein the means for halting couples the means for storing, the means for executing, and the means for controlling.
